(19) United States
(12) Patent Application Publication
(10) Pub. No.: US 2025/0378575 A1
(43) Pub. Date: Dec. 11, 2025

(54) Tracking Occluded Objects in Hand

(71) Applicant: Apple Inc., Cupertino, CA (US)

(72) Inventors: Feng Zheng, San Mateo, CA (US); Erik Nelson, Cupertino, CA (US); Kyel Ok, Cupertino, CA (US); Waleed Abdulla, Mountain View, CA (US)

(21) Appl. No.: 19/212,082

(22) Filed: May 19, 2025

Related U.S. Application Data
(60) Provisional application No. 63/657,359, filed on Jun. 7, 2024.

(51) Int. Cl. G06T 7/73; G06T 7/20; G06T 17/00; G06V 10/26

(52) U.S. Cl. CPC G06T 7/73; G06T 7/20; G06T 17/00; G06V 10/26

(57) ABSTRACT

Hand-held controllers continue to be tracked when illuminators on the controllers are occluded. Image data is captured of a hand holding a physical controller with illuminators, and motion sensor data is received from the controller. A determination is made as to whether illuminator-based pose detection is reliable based on the visibility of the illuminators. When the illuminator-based pose detection is not considered reliable, the controller's pose is determined using hand-tracking data for the hand holding the controller. Tracking information for the controller is determined by considering the spatial relationship between the hand and controller in previous frames and adjusting parameters based on a visibility metric. This facilitates generating virtual content that corresponds with the physical controller's current pose.

### BACKGROUND

Some devices can generate and present Extended Reality (XR) Environments. An XR environment may include a wholly or partially simulated environment that people sense and/or interact with via an electronic system. In XR, a subset of a person's physical motions, or representations thereof, are tracked, and in response, one or more characteristics of one or more virtual objects simulated in the XR environment are adjusted in a manner that comports with realistic properties.

Handheld controllers can be used in XR environments to enhance user input. Handheld controllers can be used as input systems to interact with the virtual environment. This can enhance the immersive experience and provide a more intuitive and natural way to interact with the virtual content. These controllers can be tracked by the system to provide input. For example, image data of the controller can be captured to determine characteristics of the corresponding input. However, what is needed is improvements to track controllers when they are occluded in image data used for tracking. The controllers may also include haptic feedback, allowing the user to feel tactile sensations as they interact with the virtual environment.

### BRIEF DESCRIPTION OF THE DRAWINGS

FIG. 1A shows example image data of a user interacting with a controller in an extended reality environment, in accordance with some embodiments.

FIG. 1B shows example hand tracking data corresponding to the image data of FIG. 1A, in accordance with one or more embodiments.

FIG. 1C shows example position and orientation information for a hand and controller corresponding to the image data of FIG. 1A, in accordance with one or more embodiments.

FIG. 2 shows a flow diagram of a technique for obtaining position and orientation output from image data and motion data, in accordance with one or more embodiments.

FIG. 3 shows a flowchart of a technique for determining a pose of a controller, in accordance with some embodiments.

FIG. 4 shows a flow diagram of a technique for using hand tracking data to determine a controller pose, in accordance with some embodiments.

FIG. 5 shows a flow diagram of an alternative technique for determining controller position and orientation output, in accordance with some embodiments.

FIG. 6 shows a system diagram of an electronic device which can be used for gesture recognition, in accordance with one or more embodiments.

FIG. 7 shows an exemplary system for use in various extended reality technologies.

### DETAILED DESCRIPTION

This disclosure pertains to systems, methods, and computer readable media to enable controller detection and input in an extended reality environment. In particular, techniques described herein are directed to relying on hand tracking data to determine position and orientation information of a handheld controller when illuminators on the controller are occluded.

In some enhanced reality contexts, handheld controllers can be used to generate user input. These handheld controllers may be tracked to determine characteristics of the motion or pose of the controller, which can then be translated into user input. As an example, a handheld controller may include one or more illuminators, such as light emitting diodes (LEDs), which can emit light that can be detected in the image data by a user device in order to track the controller. Similarly, other features of the controller can be tracked in image data to determine characteristics of the movement of the controller. However, when the illuminators or other tracked features are occluded, the accuracy of the detected characteristics of the motion may suffer. When it comes to a handheld controller, occlusion maybe more likely, because a user may occlude the illuminators by covering or concealing the illuminators with their hand, or manipulating the controller in such a way that the illuminators are not visible in the image data used to track the controller.

The technique described herein relies on hand tracking data when illuminator-based pose detection of the controller is determined to be unreliable or, alternatively, adjusting a reliance on hand tracking data and illuminator-based pose detection depending upon a degree of visibility of at least a portion of the illuminators. For example, hand tracking data can be fused with motion data, such as IMU data from the controller, to infer the pose of the controller when the controller is determined to be in a pose in which illuminator-based posed detection is considered to be unreliable. By saving an indication of a relationship between the controller and the hand when the illuminators are visible, the relationship can be applied to a frame in which the illuminators are not visible by inferring that a grip of the controller is consistent.

In some embodiments, a combined network can be trained that jointly predicts hand pose and controller pose based on image data and/or motion data which is fused together. The combined network can ingest image data captured by a user device with motion data transmitted from the controller, and apply it to the network. The network may be configured to jointly predict hand pose and controller pose. In some embodiments, the network may be configured to differently weight the inputs based on a visibility of illuminators in the image data. In some embodiments, the network may be additionally configured to estimate a transform between the controller pose and the hand pose, which may similarly be relied upon in future frames where illuminators are not visible, or for which the controller is captured in the image data in such a manner that the illuminators may not be visible or may be insufficiently visible.

Techniques described herein provide a technical improvement to illuminator-based controller tracking by allowing a controller to be tracked even when illuminators or other trackable features become occluded. In turn, the handheld controller is improved because the positioning of the illuminators may be placed on portions of the controller which may not always be visible, thereby providing flexibility in handheld controller design. Accordingly, while the form factor of many controllers is limited to ensure that illuminators remain visible, embodiments herein provide a technique to allow a greater range of designs. Embodiments described herein further provide a technical improvement to tracking handheld controllers by taking advantage of hand tracking data as a secondary input for determining the pose of a controller, which may be generated regardless of controller tracking for other extended reality purposes. Hand tracking data may improve accuracy when illuminators are not well presented in image data.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description for purposes of explanation, numerous specific details are set forth in order to provide a thorough understanding of the disclosed concepts. As part of this description, some of this disclosure's drawings represent structures and devices in block diagram form, to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system-and business-related constraints) and that these goals may vary from one implementation to another. It will also be appreciated that such development efforts might be complex and time-consuming but would nevertheless, be a routine undertaking for those of ordinary skill in the design and implementation of graphics modeling systems having the benefit of this disclosure.

### Example Technique for Hand and Controller Tracking

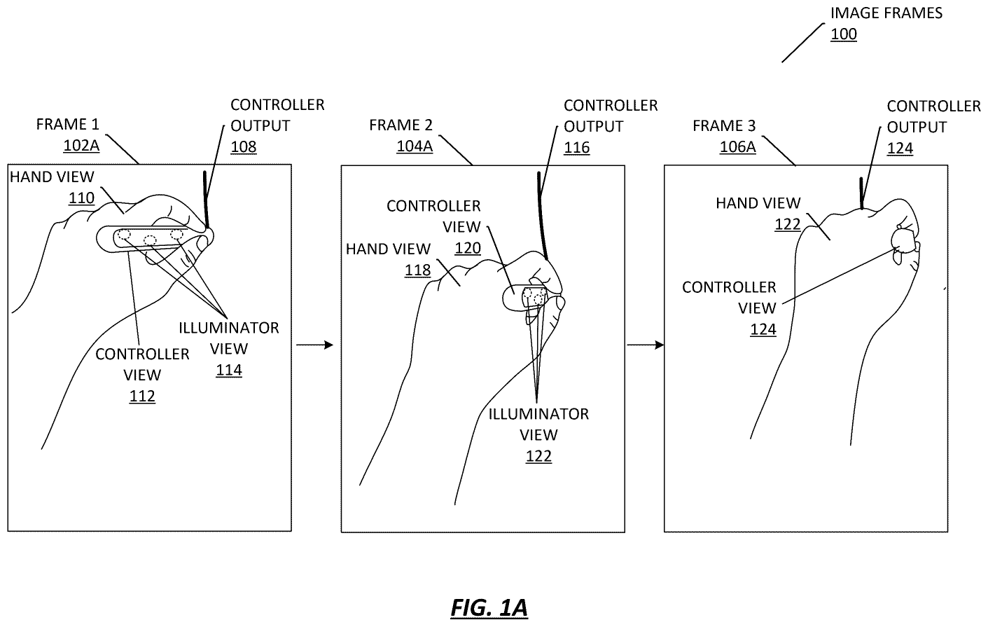

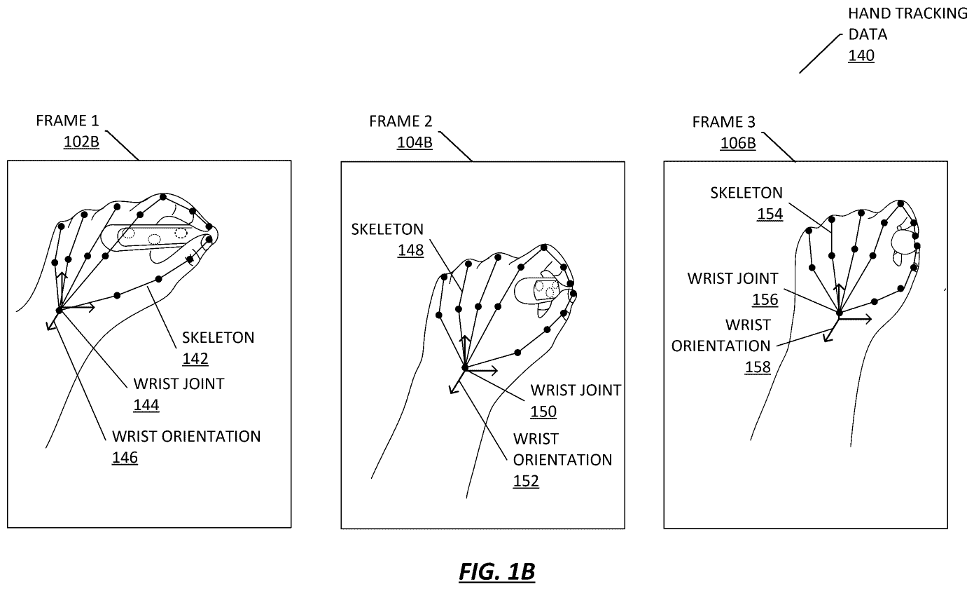

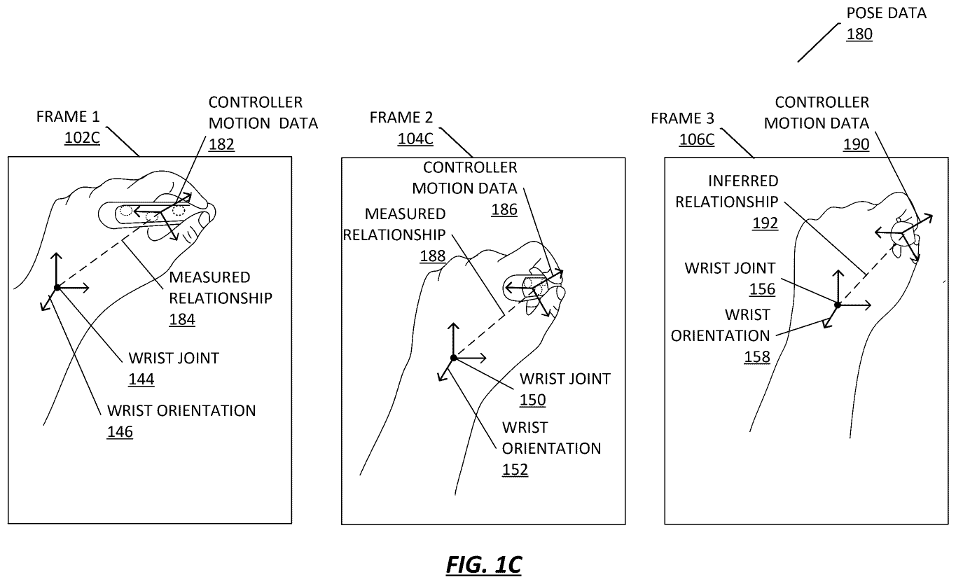

FIGS. 1A-C show an example of sensor data captured over a set of frames. In particular, FIGS. 1A-C, show different examples of sensor data and features that may be captured or generated for a particular set of frames. It should be understood that the various features and description of FIGS. 1A-C, are provided for illustrative purposes and are not necessarily intended to limit the scope of the disclosure.

FIG. 1A depicts a series of frames in which a controller position and/or orientation is used to generate user input. In particular, the example series of image frames 100 include frame 1 102A, frame 2 104A, and frame 3 106A. In frame 1 102A, a hand of a user is visible at hand view 110. The hand is holding a controller, visible at controller view 112. The controller may be a handheld physical controller which is configured to generate user input based on motion information of the controller. As shown, the controller is being manipulated by the hand to generate controller output 108. According to some embodiments, controller output 108 may be virtual content generated and presented in an extended reality environment. That is, while the controller output 108 is visible in the frame 102A, the controller output 108 may be rendered and composited in the frame 1 102A after image data for the frame is captured and prior to presentation of the frame.

A hand of a user is visible at hand view 110. The hand is holding a controller, visible at controller view 112. The controller may be a handheld physical controller which is configured to generate user input based on motion information of the controller. As shown, the controller is being manipulated by the hand to generate controller output 108. According to some embodiments, controller output 108 may be virtual content generated and presented in an extended reality environment. That is, while the controller output 108 is visible in the frame 1 102A, the controller output 108 may be rendered and composited in the frame 1 102A after image data for the frame is captured and prior to presentation of the frame.

According to one or more embodiments, the controller depicted at controller view 112 may include components which may facilitate the determination of the position and/or orientation of the controller. For example, the controller may include a motion sensor, such as a gyroscope, accelerator, inertial motion unit (IMU), or the like. In addition, the controller may include one or more illuminators, shown at illuminator view 114, which may emit or reflect light which, when detected in the image data or by a sensor, can be used to determine position and/or orientation information for the controller. in some embodiments, the illuminators may include LEDs or the like, and may be configured to emit visible or invisible light. Alternatively, the illuminators may be configured to reflect light emitted from another source. In some embodiments, the illuminators may be affixed in the controller in a predefined pattern or constellation such that the relative location of the illuminators can be used to determine the pose of the controller to which the illuminators belong. Thus, a pose of the controller shown at controller view 112 determined based on the illuminators shown at illuminator view 114, along with, in some embodiments, motion data from a motion sensor that is part of the controller.

As the hand moves the controller in the environment, the visibility of the controller within the image data will change. For example, as shown at frame 2 104A, the hand has moved slightly downward and to the right, generating additional controller output 116 based on the movement of the controller between frames. Notably, the user has manipulated the controller in such a way that the hand view 118 shows a slight rotation in the hand, resulting in a rotated controller view 120. Accordingly, the illuminators become less visible in frame 2 104A as compared to frame 1 102A, as is shown by illuminator view 122. In some embodiments, because the illuminators are still visible in illuminator view 120, the motion characteristics of the controller output 116 may be determined, at least in part, by a configuration of the illuminators in illuminator view 122. However, in some embodiments, the motion characteristics of the controller may be additionally, or alternatively, determined based on other sensor data, such as hand tracking data, which will be described in greater detail below with respect to FIG. 1B.

The process is further made clear when considering frame 3 106A, the hand has continued to move the controller up and to the right, generating additional controller output 124 based on the movement of the controller between frames. Here, because of the field of view of the camera capturing the frame, the hand is obscuring much of the controller output 124. The user has manipulated the controller in such a way that the hand view 122 shows the hand even further rotated than in the prior frames 102A and 104A, resulting in a controller view 124, in which only the tip of the controller is visible. In controller view 124, the illuminators are no longer visible. Accordingly, the illuminators can no longer be relied upon for determining motion characteristics of the controller. In some embodiments, the motion characteristics of the controller may be determined based on available sensor data for the controller, such as motion sensor data transmitted from the controller. In addition, hand tracking data may be used to determine the motion characteristics of the controller.

Turning to FIG. 1B, a series of frames of example hand tracking data is presented. In particular, the example series of frames of hand tracking data 140 include frame 1 102B, frame 2 104B, and frame 3 106B. Frame 1 102B represents hand tracking data that correspond to frame 1 102A of image frames 100. Similarly, frame 2 104B represents hand tracking data that correspond to frame 2 104A, and frame 3 106B represents hand tracking data that correspond to frame 3 106A. According to some embodiments, sensor data may be captured of a user's hand and applied to a hand tracking pipeline to obtain information which can be used to derive characteristics of the pose and location of the hand or portions of the hand. In some embodiments, hand tracking data may include one or more joint poses for the hand. According to one or more embodiments, the hand tracking data may be derived from sensor data captured by a user device, such as image data and/or depth data. The image data may be obtained from one or more cameras, including stereoscopic cameras or the like.

In frame 1 102B, example hand tracking data includes a set of joints which comprise a skeleton 142. In some embodiments, position information may be determined for each joint, or for each portion of the hand. The position information may include, for example, location information, pose information, and/or motion information, such as a 6 degrees of freedom (6 DOF) representation. The collection of joint information can be used to predict the skeleton, and to predict a hand pose, which can be used to determine example wrist joint 144 as shown, along with wrist orientation 146.

Frame 2 104B includes hand tracking data corresponding to the image data from frame 2 104A from FIG. 1A. In frame 2 104B, example hand tracking data includes a set of joints which comprise a skeleton 148. The joint information may include wrist joint 150 and wrist orientation 152. Similarly, frame 3 106B includes hand tracking data corresponding to the image data from frame 3 106A from FIG. 1A. In frame 3 106B, example hand tracking data includes a set of joints which comprise a skeleton 154. The joint information may include wrist joint 156 and wrist orientation 158.

According to one or more embodiments, the sensor data from the controller and the user device may be fused to enhance and improve tracking of the controller, for example in general, or when the controller is occluded. Turning to FIG. 1C, example pose data 180 for the series of frames is presented. In particular, the example series of frames of pose data 180 include frame 1 102C, frame 2 104C, and frame 3 106C. Frame 1 102C represents pose data that correspond to frame 1 102A of image frames 100. Similarly, frame 2 104C represents hand tracking data that correspond to frame 2 104A, and frame 3 106C represents hand tracking data that correspond to frame 3 106A.

According to one or more embodiments, when a pose of a controller cannot be confidently determined from sensor data for the controller (for example, based on illuminators detected on the controller), hand tracking data may be used to enhance the signals used to determine controller pose. In particular, a relationship between the hand and the controller in a frame when the controller is not occluded (or, more specifically, sufficiently visible to determine pose information without reliance on hand tracking data) can be determined and used in a later frame in which the controller is occluded (or sufficiently occluded such that the controller cannot be confidently determined without additional signals).

As shown in frame 1 102C, the illuminators of the controller are visible. In addition, the controller may provide controller motion data 182. Controller motion data 182 may be provided, for example, from a motion sensor, such as a gyroscope, accelerometer, IMU, or other sensor configured to provide motion information. In some embodiments, the controller motion data 182 may be used in conjunction with the visible illuminators to determine the pose of the controller in frame 1 102C. In addition, hand tracking data may be collected which provides position and orientation information for various portions of the hand, as described above with respect to FIG. 1B. The motion of the hand may be represented by hand tracking data for one or more joints in the hand. In the example of FIG. 1C, the wrist joint 144 is used as a reference for the position and orientation of the hand. Thus, wrist orientation 146 may be obtained from the hand tracking data, as shown in FIG. 1B. In addition, a relationship between the hand pose information and the controller pose information may be determined, as shown by measured relationship 184. In the example shown, the measured relationship 184 may represent a transformation between the wrist orientation 146 and the controller motion data 182. The measured relationship 184 may correspond to a grip of the controller.

Turning to frame 2 104C of pose data 180, the illuminators of the controller are visible. In addition, the controller may provide additional controller motion data 186. In addition, hand tracking data may be collected which provides position and orientation information for various portions of the hand, as described above with respect to FIG. 1B, such as wrist joint 150 and wrist orientation 152. In addition, a relationship between the hand pose information and the controller pose information may be determined, as shown by measured relationship 188. In the example shown, the measured relationship 188 may represent a transformation between the wrist orientation 152 and the controller motion data 186. In addition, the measured relationship 188 may be the same, or may differ from measured relationship 184 of frame 1 102C.

Turning to frame 3 106C, the illuminators of the controller are no longer visible. As such, illuminator-based pose detection is not feasible based on the pose of the controller in frame 3 106C. Rather, alternative signals can be relied upon to infer the position and motion of the controller. In particular, the controller may continue to provide controller motion data 190. Further, hand tracking data may be obtained, such that wrist joint 156 and wrist orientation 158 can be determined. The controller can be tracked by inferring a stable grip from the prior frame. Said another way, the measured relationship 188 can be applied to the wrist orientation 158 and controller motion data 190 to track the wand. In doing so, the controller can continue to be used for output even when the illuminators are not positioned in a way such that illuminator-based pose detection is feasible. For example, based on the controller motion data 190, inferred relationship 192 (for example, from measured relationship 188 of prior frame 2 104C), and wrist orientation 158, motion information for the controller can be determined to continue providing user input.

### Example Data Flow

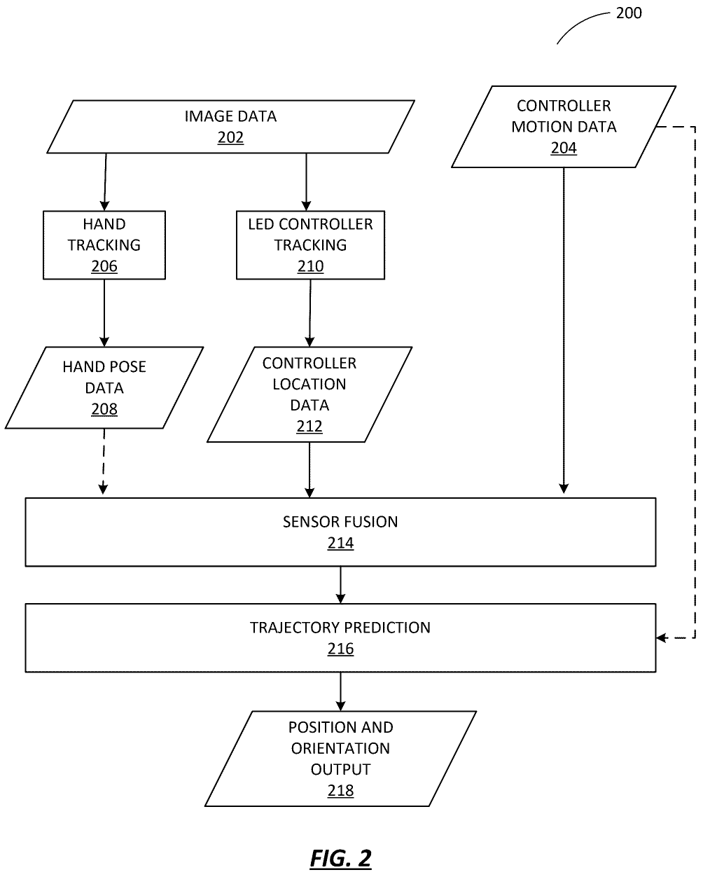

FIG. 2 shows a flow diagram of a technique for obtaining position and orientation output from image data and motion data, in accordance with one or more embodiments. In particular, FIG. 2 shows a position and orientation output pipeline in which a user input from a controller is recognized and processed. Although the flow diagram shows various components which are described as performing particular processes, it should be understood that the flow of the diagram may be different in accordance with some embodiments, and the functionality of the components may be different in accordance with some embodiments.

The flow diagram 200 begins with image data 202. In some embodiments, the image data may include image data and/or depth data captured of a user's hand or hands, and/or of a physical controller being manipulated by the user's hand or hands. In some embodiments, the sensor data may be captured from sensors on an electronic device, such as outward facing cameras on a head mounted device, or cameras otherwise configured in an electronic device to capture sensor data including a user's hands. According to one or more embodiments, the sensor data may be captured by one or more cameras, which may include one or more sets of stereoscopic cameras. In some embodiments, in addition to the image data 202, additional sensor data collected by an electronic device and related to the user. For example, the sensor data may provide location data for the electronic device, such as position and orientation of the device. Further, with respect to the physical controller, the image data may be configured to detect visible and invisible light emitted from the controller.

In some embodiments, the image data 202 may be applied to a hand tracking module 206. The hand tracking module may be configured to estimate a physical state of a user's hand or hands. In some embodiments, the hand tracking module 206 determines a hand pose data 208. In some embodiment, the hand tracking module 206 may include a network trained to predict characteristics of the hand from image data. The hand pose data may provide an estimation of joint locations and/or orientations for a hand. Further, the hand tracking module 206 may be trained to provide an estimation of an estimate of a device location, such as a headset, and/or simulation world space such that the relative position of the hand or portions of the hand can be determined.

According to one or more embodiments, the image data 202 may additionally be applied to an LED controller tracking module 210. The LED controller tracking module 210 may be configured to detect the illuminators in the image data and determine position and orientation information for the physical controller based on the detected configuration of the illuminators in the image data. For example, the illuminators may be affixed in the physical controller in a predefined constellation such that the particular layout and orientation of the light emitters captured in image data can be used to determine position and orientation information for the physical controller. Accordingly, controller location data 212 can be determined from the LED controller tracking 210.

The flow diagram 200 also includes obtaining controller motion data 204. As described above, the physical controller may comprise a motion sensor along with the illuminators, which may be used to collect and provide motion sensor data indicative of a motion of the physical controller. The controller motion data may provide information such as movement information, pose, or the like. In some embodiments, the controller is paired with a system collecting the hand tracking data such that the controller transmits the motion data.

The flow diagram 200 proceeds at sensor fusion module 214. According to some embodiments, sensor fusion module 214 may be configured to obtain the controller motion data 204 and the controller location data 212 to determine position and orientation information for the controller. For example, the controller location data 212 may be obtained in a first coordinate system, such as an HMD coordinate system. By contrast, controller motion data 204 may be obtained in a second coordinate system, such as a coordinate system associated with the controller. Thus, sensor fusion 214 may be used to combine the various data types into a single coordinate system such that position and orientation information for the controller can be determined.

In some embodiments, hand pose data 208 may additionally be incorporated into the sensor fusion module 214. In particular, as described above, hand pose information for a particular frame, such as an orientation of the hand, may be mapped to the controller data, such as controller motion data 204, and or controller location data 212. Accordingly, while hand pose data 208 may not be used to determine position and orientation information for the controller in every frame, by mapping the hand pose data to the controller data in a particular frame, the mapping may be used to infer spatial relationship characteristics between the hand and the controller when the controller data is unavailable or unreliable in a later frame.

In some embodiments, the controller location data 212 and the controller motion data 204 be fused in order to determine characteristics of the position of the controller for user input. In particular, trajectory prediction 216 may be performed to determine a position and orientation output 218 of the controller. For example, the location of the tip of the controller may be determined based on the controller location data 212. Accordingly, returning to the example of FIG. 1, the position and orientation output may be used to affect the controller output 108. According to some embodiments, the position and orientation information may primarily rely on controller-based sensor data, but may fall back on hand tracking data to determine position and orientation information for the controller when controller-based sensor data is unavailable or unreliable. Further, in some embodiments, trajectory prediction may be refined by relying on most current controller motion data. For example, by the time the sensor fusion 214 is complete, additional controller motion data 204 may be available. Thus, trajectory prediction 216 may rely on the sensor fusion 214 as well as current controller motion data 204 to determine position and orientation output 218.

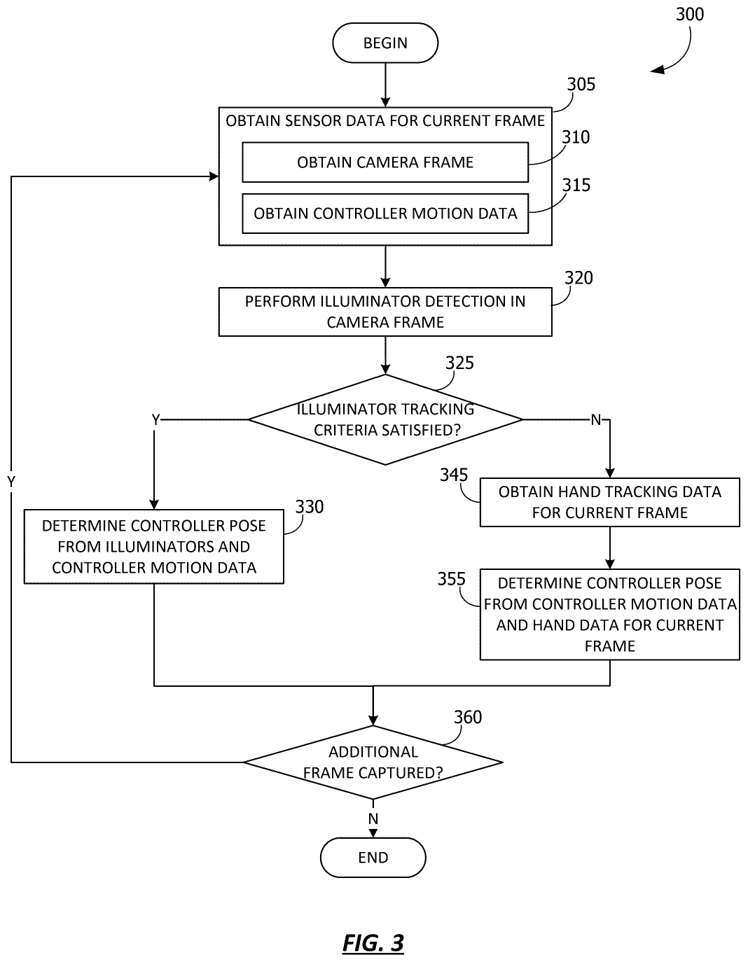

FIG. 3 shows a flowchart of a technique for determining a pose of a controller, in accordance with some embodiments. In particular, the flowchart presented in FIG. 3 depicts an example technique for adjusting signals used for determining controller pose, as described above with respect to FIGS. 1-2. For purposes of explanation, the following steps will be described as being performed by particular components. However, it should be understood, that the various actions may be performed by alternate components. In addition, the various actions may be performed in a different order. Further, some actions may be performed simultaneously, and some may not be required, or others may be added.

The flowchart 300 begins at block 305, where sensor data is obtained for a current frame. According to one or more embodiments, the sensor data may include depth data, image data, motion data, or some combination thereof. At block 310, camera frame data is obtained. The camera frame data may be captured from a single camera system, or a multi-camera system such as stereoscopic cameras or the like. In some embodiments, the camera frame data may be captured by outward facing cameras of a head mounted device.

According to one or more embodiments, obtaining sensor data at block 305 also includes obtaining data from external devices, such as obtaining controller motion data as shown at block 315. Controller motion data may be received from a controller and may include sensor data related to controller motion or position. For example, the controller may include an accelerometer, gyroscope, IMU, or the like, which obtains sensor data related to the motion and/or position of the controller. The controller may be paired with the HMD or other electronic device to use the controller motion data in conjunction with camera data to determine controller position.

The flowchart 300 proceeds to block 320. At block 320, illuminator detection is performed on the image data. In some embodiments, the image data may be processed to determine whether the illuminators are present in the captured image data. Said another way, the illuminator detection may be used to identify unoccluded illuminators. In some embodiments, illuminators may be occluded based on an orientation of the controller such that the illuminators are not in the field of view of the camera. As another example, illuminators may be affixed in a handle of the controller such that a hand may occlude at least some of the illuminators when a user is manipulating the controller. At block 325, a determination is made as to whether an illumination tracking criteria is satisfied. In some embodiments, the illuminator tracking criteria may indicate a threshold visibility of one or more of the illuminators required to determine that illuminator-based tracking is reliable based on the image frame. For example, a minimum number of illuminators may need to be present. As another example, the layout of the illuminators may be required to be visible at a particular angle.

If at block 325, a determination is made that the illuminator tracking criteria is satisfied, then the flowchart 300 proceeds to block 330. At block 330, the controller pose is determined from the illuminators and the controller motion data. In particular, a pose of the controller is determined by comparing the visible orientation of the illuminators to a known layout of the illuminators in the device. In addition, motion data from the controller may be used to determine changes in orientation. For example, turning to frame 1 102A of FIG. 1A, controller view 112 includes illuminator view 114, including three illuminators along one side of the controller. By detecting the location of these illuminators in frame 1 102A, position and orientation information for the controller can be derived. In addition, the controller may be configured to provide motion data, such as in controller motion data 182 of frame 1 102C. Accordingly, the controller pose may be determined from the illuminator tracking and the controller motion data.

Returning to block 325, if a determination is made that the illuminator tracking criteria is not satisfied, then the flowchart 300 proceeds to block 345. For example, the illuminator tracking criteria may not be satisfied if a threshold number of illuminators are not visible in the image data, or if a threshold portion of a constellation of illuminators are not presented. At block 345, hand tracking data is obtained for the current frame. For example, hand tracking data may be obtained from a hand tracking module, which may be derived from image and/or depth data of the hand. In some embodiments, hand tracking data is derived from the one or more camera frames from or other frames of sensor data, for example, from block 305. The hand tracking data may be obtained from hand tracking module 206, or another source which generates hand tracking data from camera or other sensor data. In some embodiments, the hand tracking module may be running concurrently with the controller tracking technique described herein. As such, the hand tracking data may be readily available when needed, such as when illuminator tracking criteria is not satisfied at block 325.

The flowchart 300 proceeds to block 355, where the controller pose is determined from the controller motion data and the hand data for the current frame. That is, when the illuminator tracking criteria is not satisfied, an alternative tracking technique is used, in which the controller is tracked based on the controller pose from the prior frame and hand data for the current frame. As an example, returning to FIG. 1C, in frame 3 106C, the illuminators on the controller are not visible. However, the controller motion data 190 may provide some indication of a position or location of the controller. For example, the controller motion data may provide an indication of motion from a prior frame in which illuminator tracking was used based on motion data captured between the prior frame and the current frame. A grip can be inferred based on an observed relationship between the hand and the controller from a prior frame. Thus, if the illuminator tracking criterion is not satisfied, then the controller pose may fall back on a prior-observed relationship between the controller and the hand to determine a current controller pose based on hand tracking data. Again, as in FIG. 1C, frame 3 106C may fail to satisfy the illuminator tracking criteria, but hand tracking in the form of wrist orientation 158 and wrist joint 156 may be available. In addition, the system may rely on the measured relationship 188 from frame 2 104C, which was measured at a time when the illuminators were visible on the controller. Thus, a revised location and orientation of the controller can be determined, along with motion data, using the inferred relationship.

Because the process is performed dynamically and continuously, the flowchart 300 continues at block 360, where a determination is made as to whether additional frames are captured. If additional frames are captured, the flowchart repeats for additional frames, and the controllers continue to be tracked depending upon whether illuminator tracking is available. If a determination is made at block 360 that no additional frames are captured, then the flowchart 300 concludes. For example, if the process may cease if the controller is no longer being tracked, if the tracking system is powered down, or the like.

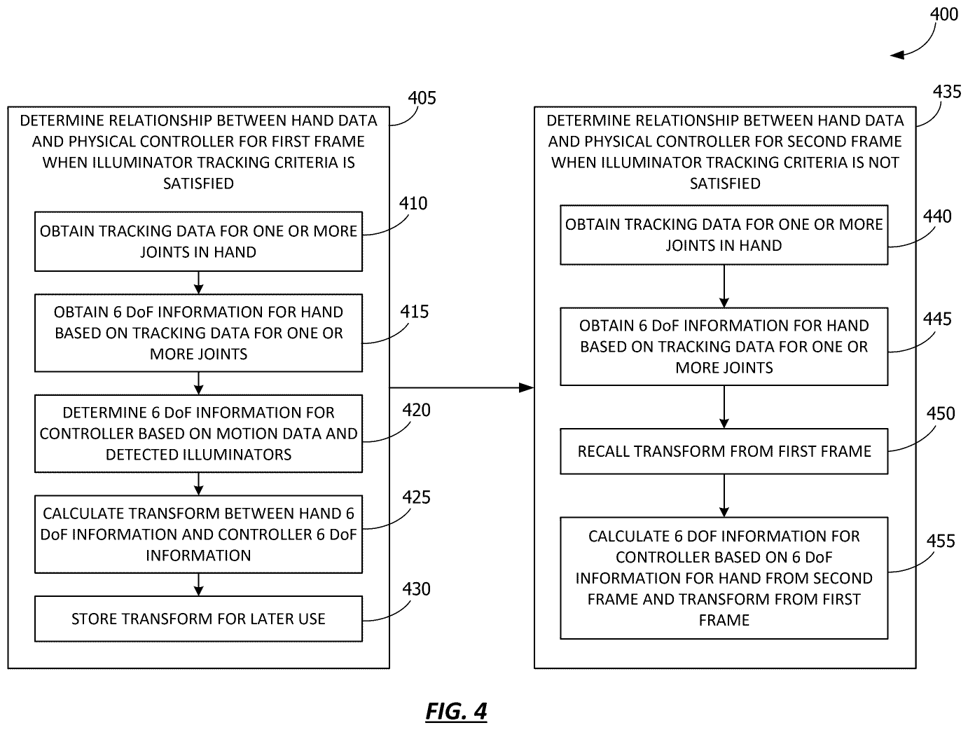

The relationship between hand tracking data and a physical controller may be determined in a number of ways. Similarly, the use of hand tracking data and relationship data from a prior frame may be applied in a number of ways. FIG. 4 shows a flow diagram of a technique for using hand tracking data to determine a controller pose, in accordance with some embodiments. In the example shown, a two-step process is depicted, in which and when illuminator tracking criteria is satisfied for first frame, but is not satisfied for a second frame.

The flowchart begins at block 405, where a relationship is determined between hand data and a physical controller for a first frame when illuminator tracking criteria is satisfied. For example, returning to frame 2 104C of FIG. 1C, illuminators are visible and, thus, the relationship between the wrist orientation 152 and the controller motion data 186 is mapped in the form of measured relationship 188 for later use. Returning to FIG. 4, determining the relationship may include, at block 410, acquiring tracking data for one or more joints in the hand. Hand tracking data is obtained from a hand tracking pipeline that uses sensor data captured by a user device, such as image data and/or depth data of the user's hand. This data is applied to the hand tracking pipeline to obtain information that can be used to derive characteristics of the pose and location of the hand or portions of the hand. In some embodiments, hand tracking may be performed regardless of the controller tracking technique used. Thus, even if the illuminator-based tracking technique is used such that the controller is tracked regardless of the hand tracking data, the hand tracking data may still be available to be used to store a mapping between the hand tracking and the controller tracking.

At block 415, six degrees of freedom (6 DOF) position information is derived for the hand based on the joint tracking data. The position information may include location information, pose information, and/or motion information, such as a 6 degrees of freedom (6 DOF) representation of a particular joint or portion of the hand. For example, returning back to FIG. 1C, the wrist orientation 152 is provided by the hand tracking module. In some embodiments, the 6 DOF position information for the hand may be derived from multiple joints, such as a wrist, base pinky knuckle, and base index finger knuckle. Thus, the 6 DOF position and orientation information may be obtained directly from hand tracking data in the form of a single joint pose, or may be generated from pose information from multiple joints.

The flowchart proceeds to block 420, where 6 DOF position information for the controller is determined. In some embodiments, when the illuminators are positioned in a manner such that illuminator-based tracking can be performed, then the detected illuminators in the image data can be used to determine a pose of the controller. For example, the controller may include the illuminators in a known constellation such that the constellation can be recognized in image data. Additionally, or alternatively, the controller may be configured to alternately emit light from different illuminators in a predefined pattern such that the pattern of illumination can be used to determine position information. Further, the 6 DOF position information can be refined based on motion sensor data collected by a motion sensor of the controller, such as an IMU, accelerometer, gyroscope, or the like.

At block 425, a transform is computed between the hand's 6 DOF position and the controller's 6 DOF position. According to one or more embodiments, the relationship between the hand and the controller can be measured in the form of the transform between the two 6 DOF values. Accordingly, the transform can be used to define a grip of the controller. At block 430, the transform is stored for subsequent use.

The flowchart 400 proceeds to block 435. At block 435, a relationship is determined between the hand data and the physical controller for a second frame when the illuminator tracking criteria is not satisfied. For example, returning to FIG. 1C, the illuminator tracking criteria may not be satisfied in frame 3 106C, as the illuminators are not visible from the perspective of the camera. Said another way, whereas block 405 referred to a frame in which the illuminators were visible, such as frame 2 104C, block 435 refers to a frame in which the illuminators are not visible, or not sufficiently visible to satisfy an illuminator tracking threshold, as in frame 3 106C. Thus, an inferred relationship of the hand and the controller is determined in order to identify position and orientation information of the controller.

Determining the relationship includes, at block 440, obtaining tracking data for one or more joints in the hand. As described above, hand tracking data is obtained from a hand tracking pipeline that uses sensor data captured by a user device, such as image data and/or depth data of the user's hand. This data is applied to the hand tracking pipeline to obtain information that can be used to derive characteristics of the pose and location of the hand or portions of the hand.

At block 445, 6 DOF position information is obtained for the hand based on the tracking data for one or more joints. The position information may include location information, pose information, and/or motion information, such as a 6 degrees of freedom (6 DOF) representation of a particular joint or portion of the hand.

The flowchart 400 proceeds to block 450, where, because the illuminator tracking criteria is not satisfied, the prior transform is recalled, for example, from block 430. That is, because the illuminators are not sufficiently visible in the current frame, a prior relationship between the hand and the controller is recalled and used to infer the relationship in the current frame. This may involve a presumption that the grip of the hand stays stable between the first frame and the second frame. Said another way, while the hand and controller may move from the first frame to the second frame, a presumption is used that the hand and the controller move together, thereby maintaining a stable spatial relationship.

The flowchart 400 concludes at block 455, where the system calculates 6 DOF position information for the controller based on the 6 DOF position information for the hand from the current frame, and the transform from the prior frame. In particular, the transform can be applied to the 6 DOF position and orientation information of the hand in the current frame to infer current position and orientation information for the controller. The position and orientation information of the controller can then be used to determine controller position and orientation output, according to one or more embodiments.

### Alternate Example Data Flow

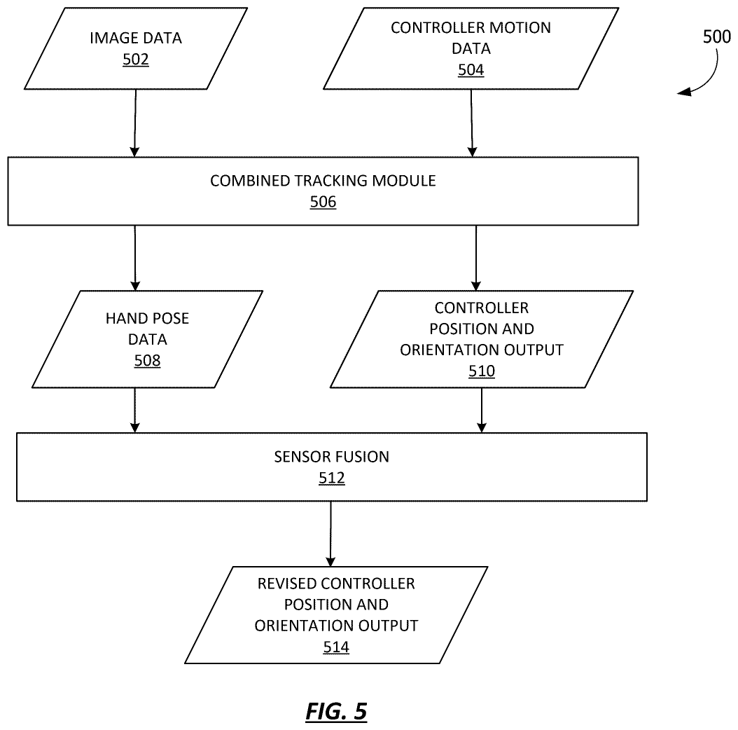

In some embodiments, an alternative technique can be used to dynamically modify how the different signals are used to determine controller tracking information and hand tracking information. FIG. 5 shows a flow diagram of an alternative technique for obtaining position and orientation output from image data and motion data, in accordance with one or more embodiments. For purposes of explanation, the following steps will be described as being performed by particular components. However, it should be understood, that the various actions may be performed by alternate components. In addition, the various actions may be performed in a different order. Further, some actions may be performed simultaneously, and some may not be required, or others may be added.

The flow diagram 500 begins with image data 502. In some embodiments, the image data may include image data and/or depth data captured of a user's hand or hands, and/or of a physical controller being manipulated by the user's hand or hands. In some embodiments, the sensor data may be captured from sensors on an electronic device, such as outward facing cameras on a head mounted device, or cameras otherwise configured in an electronic device to capture sensor data including a user's hands. According to one or more embodiments, the sensor data may be captured by one or more cameras, which may include one or more sets of stereoscopic cameras. In some embodiments, additional sensor data collected by an electronic device and related to the user. For example, the sensor data may provide location data for the electronic device, such as position and orientation of the device. Further, with respect to the physical controller, the image data may be configured to detect visible and invisible light emitted from the controller.

The flow diagram 500 also includes obtaining controller motion data 504. As described above, the physical controller may comprise a motion sensor along with the illuminators, which may be used to collect and provide motion sensor data indicative of a motion of the physical controller. The controller motion data may provide information such as movement information, pose, or the like. In some embodiments, the controller is paired with a system collecting the hand tracking data such that the controller transmits the motion data.

The sensor data for a particular frame, such as image data 502 and controller motion data 504, can then be applied to a combined tracking module 506. In some embodiments, the combined tracking module 506 may be a model trained on image data and controller motion data to concurrently predict hand pose data 508 and controller position and orientation output 510. In some embodiments, the combined tracking module 506 may make use of a joint neural network configured to predict the two outputs from the combination of image data 502 and controller motion data 504.

According to some embodiments, a sensor fusion step 512 may be applied to the hand pose data 508 and controller position and orientation output 510 based on fusion parameters. Sensor fusion module 512 may be configured to combine frames of tracking data in accordance with fusion metrics or parameters. According to one or more embodiments, the sensor fusion 512 may be configured to tune how much the hand information from the image data is weighted in order to determine a revised controller position and orientation output 514. For example, in some embodiments, a visibility metric for the illuminators can be determined based on the image data. The visibility metric may indicate how visible the illuminators are in relation to a visibility amount needed for illuminator-based tracking. A revised position and orientation of the controller 514 can then be determined based on a combination of parameters such has image data comprising the hand, image data comprising the controller, and controller motion data in accordance with the visibility metric.

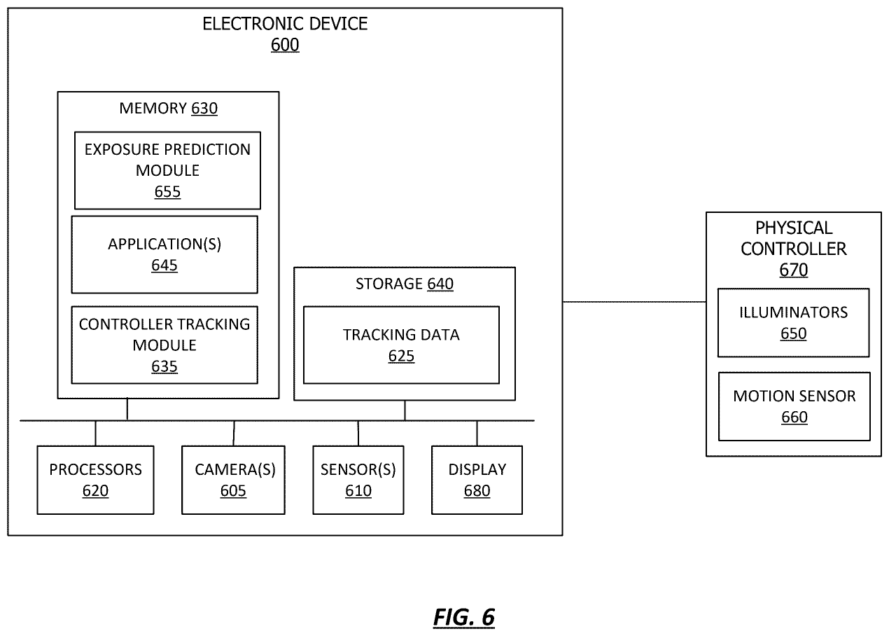

Referring to FIG. 6, a simplified system diagram is depicted. In particular, the system includes electronic device 600 and physical controller. Electronic may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 600 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 600 is utilized to interact with a user interface of an application. It should be understood that the various components and functionality within electronic device 600 may be differently distributed across the modules or components, or even across additional devices.

Electronic device 600 may include one or more processors 620, such as a central processing unit (CPU) or graphics processing unit (GPU). Electronic device 600 may also include a memory 630. Memory 630 may include one or more different types of memory, which may be used for performing device functions in conjunction with processor(s) 620. For example, memory 630 may include cache, ROM, RAM, or any kind of transitory or non-transitory computer-readable storage medium capable of storing computer-readable code. Memory 630 may store various programming modules for execution by processor(s) 620, including hand tracking module 645, and controller tracking module 635. Electronic device 600 may also include storage 640. Storage 640 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 630 may be utilized to store various data and structures which may be utilized for storing data related to hand tracking and UI preferences. Storage 640 may be configured to store hand tracking network 655 according to one or more embodiments. In addition, storage 640 may be configured to store enrollment data 625 for a user which may include user-specific characteristics used for hand tracking, such as bone length, hand size, and the like. Electronic device may additionally include a network interface from which the electronic device 600 can communicate across a network.

Electronic device 600 may also include one or more cameras 605 or other sensors 610, such as a depth sensor, from which depth of a scene may be determined. In one or more embodiments, each of the one or more cameras 605 may be a traditional RGB camera or a depth camera. Further, cameras 605 may include a stereo camera or other multicamera system. In addition, electronic device 600 may include other sensors which may collect sensor data for tracking user movements, such as a depth camera, infrared sensors, or orientation sensors, such as one or more gyroscopes, accelerometers, and the like.

According to one or more embodiments, memory 630 may include one or more modules that comprise computer-readable code executable by the processor(s) 620 to perform functions. Memory 630 may include, for example, hand tracking module 645, and controller tracking module 635. Hand tracking module 645 may be used to track locations of hands or portions of hands in a physical environment. Hand tracking module 645 may use sensor data, such as data from cameras 605 and/or sensors 610. In some embodiments, hand tracking module 645 may track user movements to determine whether to trigger user input from a detected input gesture. Controller tracking module 635 may be used to track position and orientation information for a physical controller 670, which may be used for user input, and which may be communicably paired to electronic device 600. Controller tracking module 635 may use sensor data, such as image data from cameras 605 and/or other data. For example, image data captured by camera(s) 605 may capture image data of the physical controller 670 having illuminators 650. The controller tracking module 635 can use the illuminators detected in the image data to determine position and orientation information for the physical controller. Further, physical controller 670 may additionally include a motion sensor 660 which may collect and transmit data related to motion of the physical controller. The controller tracking module 635 may use the motion sensor data along with the image data of the illuminators and/or hand tracking data from the hand tracking module 645 to determine a position and/or orientation of the physical controller. Electronic device 600 may also include a display 680 which may present a UI for interaction by a user. Display 680 may be an opaque display or may be semitransparent or transparent. Display 680 may incorporate LEDs, OLEDs, a digital light projector, liquid crystal on silicon, or the like.

Although electronic device 600 is depicted as comprising the numerous components described above, in one or more embodiments, the various components may be distributed across multiple devices. Accordingly, although certain calls and transmissions are described herein with respect to the particular systems as depicted in one or more embodiments, the various calls and transmissions may be made differently directed based on the differently distributed functionality. Further, additional components may be used, some combination of the functionality of any of the components may be combined.

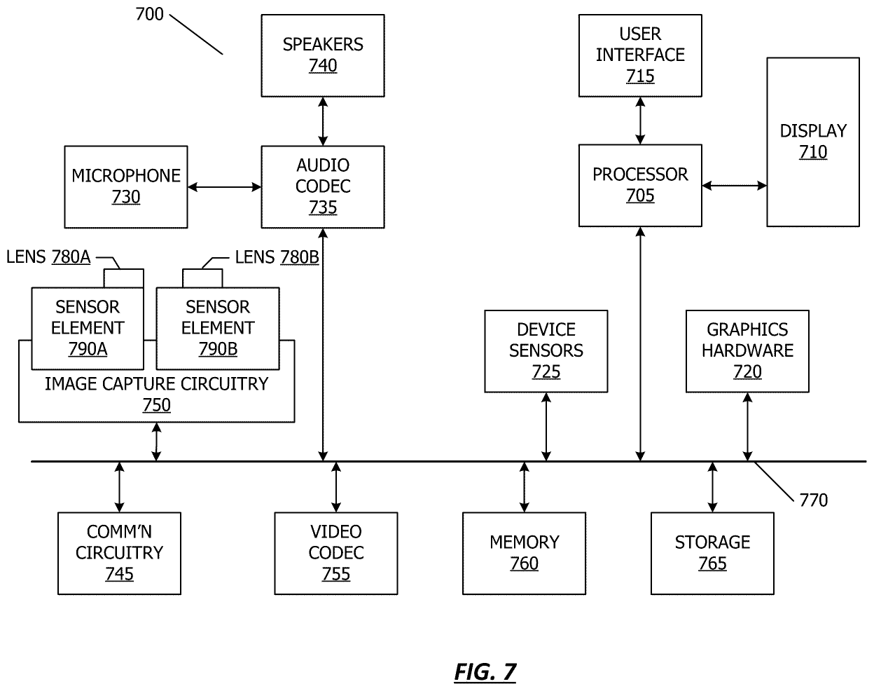

Referring now to FIG. 7, a simplified functional block diagram of illustrative multifunction electronic device 700 is shown according to one embodiment. Each of electronic devices may be a multifunctional electronic device or may have some or all of the described components of a multifunctional electronic device described herein. Multifunction electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, digital image capture circuitry 750 (e.g., including camera system), video codec(s) 755 (e.g., in support of digital image capture unit), memory 760, storage device 765, and communications bus 770. Multifunction electronic device 700 may be, for example, a digital camera or a personal electronic device such as a personal digital assistant (PDA), personal music player, mobile telephone, or a tablet computer.

Processor 705 may execute instructions necessary to carry out or control the operation of many functions performed by device 700 (e.g., such as the generation and/or processing of images as disclosed herein). Processor 705 may, for instance, drive display 710 and receive user input from user interface 715. User interface 715 may allow a user to interact with device 700. For example, user interface 715 can take a variety of forms, such as a button, keypad, dial, a click wheel, keyboard, display screen, touch screen, gaze, and/or gestures. Processor 705 may also, for example, be a system-on-chip such as those found in mobile devices and include a dedicated GPU. Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include two (or more) lens assemblies 780A and 780B, where each lens assembly may have a separate focal length. For example, lens assembly 780A may have a short focal length relative to the focal length of lens assembly 780B. Each lens assembly may have a separate associated sensor element 790A and sensor element 790B. Alternatively, two or more lens assemblies may share a common sensor element. Image capture circuitry 750 may capture still and/or video images. Output from image capture circuitry 750 may be processed by video codec(s) 755 and/or processor 705 and/or graphics hardware 720, and/or a dedicated image processing unit or pipeline incorporated within circuitry 750. Images so captured may be stored in memory 760 and/or storage 765.

Image capture circuitry 750 may capture still, and video images that may be processed in accordance with this disclosure, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705 and graphics hardware 720 to perform device functions. For example, memory 760 may include memory cache, read-only memory (ROM), and/or random-access memory (RAM). Storage 765 may store media (e.g., audio, image and video files), computer program instructions or software, preference information, device profile information, and any other suitable data. Storage 765 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 760 and storage 765 may be used to tangibly retain computer program instructions, or code organized into one or more modules and written in any desired computer programming language. When executed by, for example, processor 705 such computer program code may implement one or more of the methods described herein.

Various processes defined herein consider the option of obtaining and utilizing a user's identifying information. For example, such personal information may be utilized in order to track motion by the user. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-5, or the arrangement of elements shown in FIGS. 1 and 6-7 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
capturing, for a first frame, image data of a hand holding a physical controller, wherein the physical controller comprises a plurality of illuminators; and
in response to a determination that the image data fails to satisfy illuminator tracking criteria:
determining a current pose of the hand, and
determining a current pose of the physical controller based on the current pose of the hand.

2. The method of claim 1, wherein the current pose of the physical controller is further determined based on a spatial relationship between the hand and the physical controller in a previous frame captured prior to the first frame.

3. The method of claim 2, further comprising:
obtaining motion sensor data for the physical controller,
wherein the current pose is further determined based on the motion sensor data.

4. The method of claim 3, wherein determining the current pose of the physical controller comprises:
determining a first one or more joint poses for the hand from the previous frame;
determine a relationship between the motion sensor data and the first one or more joint poses;
determining a second one or more joint poses for the hand from the first frame; and
determining the current pose of the physical controller based on the second one or more joint poses and the relationship.

5. The method of claim 4, wherein the current pose of the physical controller is determined by applying the relationship between the motion sensor data and the first one or more joint poses to the second one or more joint poses.

6. The method of claim 1, further comprising:
capturing, for an additional frame after the first frame, image data of the hand holding the physical controller;
in response to a determination that the image data satisfies the illuminator tracking criteria:
detecting at least a subset of the plurality of illuminators in the additional frame; and
determine an additional pose of the physical controller in accordance with position and orientation information for the at least the subset of the plurality of illuminators on the physical controller.

7. The method of claim 1, wherein at least a portion of the plurality of illuminators are affixed in a handle of the physical controller.

8. The method of claim 1, wherein the illuminator tracking criteria corresponds to a threshold visibility of the plurality of illuminators in the image data.

9. The method of claim 8, wherein the image data is determined to fail to satisfy illuminator tracking criteria in response to the hand occluding a threshold portion of the plurality of illuminators.

10. The method of claim 1, further comprising:
generating virtual content in an extended reality environment in accordance with the current pose of the physical controller.

11. A non-transitory computer readable medium comprising computer readable code executable by one or more processors to:
capture, for a first frame, image data of a hand holding a physical controller, wherein the physical controller comprises a plurality of illuminators; and
in response to a determination that the image data fails to satisfy illuminator tracking criteria:
determine a current pose of the hand, and
determine a current pose of the physical controller based on the current pose of the hand.

12. The non-transitory computer readable medium of claim 11, wherein the current pose of the physical controller is further determined based on a spatial relationship between the hand and the physical controller in a previous frame captured prior to the first frame.

13. The non-transitory computer readable medium of claim 12, further comprising computer readable code to:
obtain motion sensor data for the physical controller,
wherein the current pose is further determined based on the motion sensor data.

14. The non-transitory computer readable medium of claim 13, wherein the computer readable code to determine the current pose of the physical controller comprises computer readable code to:
determine a first one or more joint poses for the hand from the previous frame;
determine a relationship between the motion sensor data and the first one or more joint poses;
determine a second one or more joint poses for the hand from the first frame; and
determine the current pose of the physical controller based on the second one or more joint poses and the relationship.

15. The non-transitory computer readable medium of claim 14, wherein the current pose of the physical controller is determined by applying the relationship between the motion sensor data and the first one or more joint poses to the second one or more joint poses.

16. A system comprising:
one or more processors; and
one or more computer readable media comprising computer readable code executable by the one or more processors to:
capture, for a first frame, image data of a hand holding a physical controller, wherein the physical controller comprises a plurality of illuminators; and
in response to a determination that the image data fails to satisfy illuminator tracking criteria:
determine a current pose of the hand, and
determine a current pose of the physical controller based on the current pose of the hand.

17. The system of claim 16, further comprising computer readable code to:
capture, for an additional frame after the first frame, image data of the hand holding the physical controller;
in response to a determination that the image data satisfies the illuminator tracking criteria:
detect at least a subset of the plurality of illuminators in the additional frame; and
determine an additional pose of the physical controller in accordance with position and orientation information for the at least the subset of the plurality of illuminators on the physical controller.

18. The system of claim 16, wherein at least a portion of the plurality of illuminators are affixed in a handle of the physical controller.

19. The system of claim 16, wherein the illuminator tracking criteria corresponds to a threshold visibility of the plurality of illuminators in the image data.

20. The system of claim 16, further comprising computer readable code to:
generate virtual content in an extended reality environment in accordance with the current pose of the physical controller.
